(19) United States
(12) Patent Application Publication
(10) Pub. No.: US 2026/0106093 A1
(43) Pub. Date: Apr. 16, 2026

(54) KEYBOARD ACCESSORY

(71) Applicant: Acer Incorporated, New Taipei City (TW)

(72) Inventors: Hung-Chi Chen, New Taipei City (TW); Hsueh-Wei Chung, New Taipei City (TW); Huei-Ting Chuang, New Taipei City (TW)

(73) Assignee: Acer Incorporated, New Taipei City (TW)

(21) Appl. No.: 19/241,388

(22) Filed: Jun. 18, 2025

(30) Foreign Application Priority Data
Oct. 16, 2024 (TW) 113139293

(51) Int. Cl. H01H 13/14; H01H 13/70

(52) U.S. Cl. CPC H01H 13/14; H01H 13/70

(57) ABSTRACT

Provided is a keyboard accessory that includes a storage base, a first key, a base, and multiple second keys. The storage base has a first mounting portion, a second mounting portion opposite to the first mounting portion, and multiple third mounting portions located between the first mounting portion and the second mounting portion. The first key is detachably engaged with the first mounting portion. The base is detachably sleeved on the second mounting portion. The multiple second keys are detachably engaged with the multiple third mounting portions.

### CROSS-REFERENCE TO RELATED APPLICATION

This application claims the priority benefit of Taiwan application serial no. 113139293, filed on Oct. 16, 2024. The entirety of the above-mentioned patent application is hereby incorporated by reference herein and made a part of this specification.

### BACKGROUND

### Technical Field

The disclosure relates to an accessory, and in particular to a keyboard accessory.

### Description of Related Art

As a common physical input operation device in a personal desktop computer or a notebook computer, a keyboard is generally composed of an arrangement of multiple keys. In order to meet users'operational needs or personalized needs, keyboard designs that facilitate the disassembly and replacement of keys have been proposed. However, the keys that are dissembled from the keyboard are not only inconvenient for users to carry around, but are also easy to get lost.

### SUMMARY

The disclosure provides a keyboard accessory that facilitates the improvement of portability and safety.

The disclosure proposes a keyboard accessory that includes a storage base, a first key, a base and multiple second keys. The storage base has a first mounting portion, a second mounting portion opposite to the first mounting portion, and multiple third mounting portions located between the first mounting portion and the second mounting portion. The first key is detachably engaged with the firs mounting portion. The base is detachably sleeved on the second mounting portion. The multiple second keys are detachably engaged with the third mounting portions.

Based on the above, in the keyboard accessory according to the disclosure, multiple replaceable keys are detachably engaged with the storage base. This design is not only convenient for users to carry around, but may also effectively reduce the risk of losing keys, facilitating users to instantly disassemble and replace keys on the keyboard according to personal needs or preferences. In addition, the storage base may accommodate more keys within a limited volume. Therefore, not only the storage volume is effectively reduced, but also the selectivity of key replacement is improved.

In order to make the features and advantages of the disclosure more comprehensible, the following examples are given and described in detail with the accompanying drawings as follows.

### BRIEF DESCRIPTION OF THE DRAWINGS

FIG. 1A is a schematic view of a keyboard accessory according to an embodiment of the disclosure.

FIG. 1B is a cross-sectional schematic view of the keyboard accessory in FIG. 1A along a line segment 1B-1B.

FIG. 1C is a cross-sectional schematic view of the keyboard accessory in FIG. 1A along a line segment 1C-1C.

FIG. 1D is an enlarged schematic view of the region 1D in FIG. 1C.

FIG. 2 is a cross-sectional schematic view of a keyboard accessory according to another embodiment of the disclosure.

FIG. 3 is a schematic view of a combination of the keyboard accessory in FIG. 1C and the keyboard accessory in FIG. 2.

### DESCRIPTION OF THE EMBODIMENTS

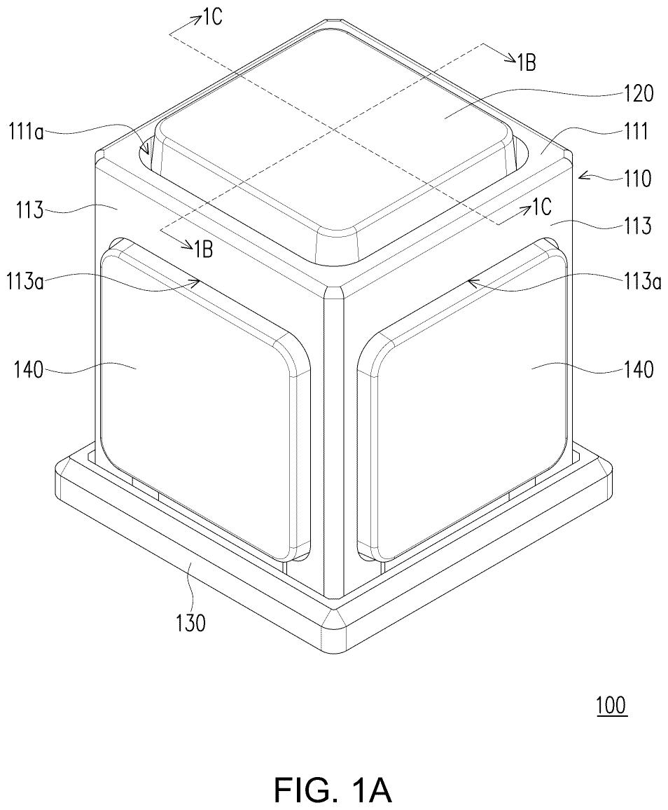

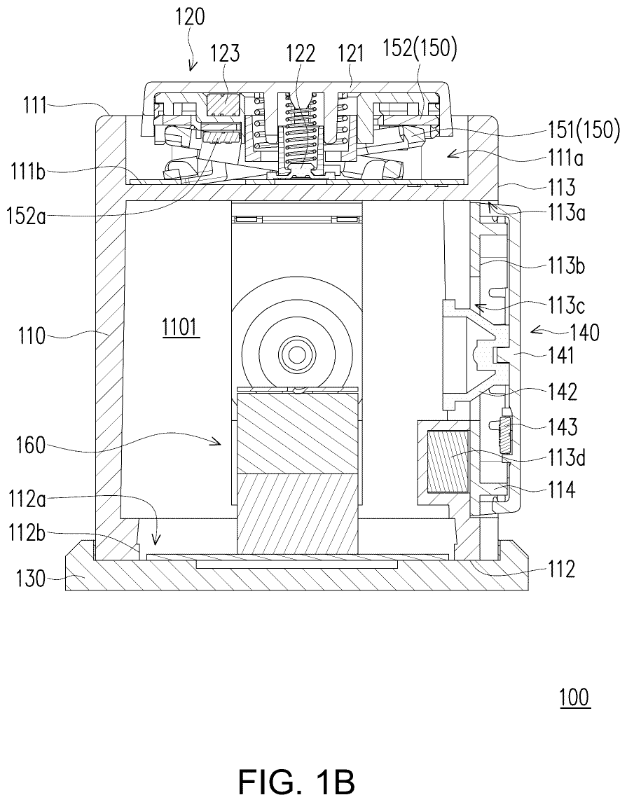

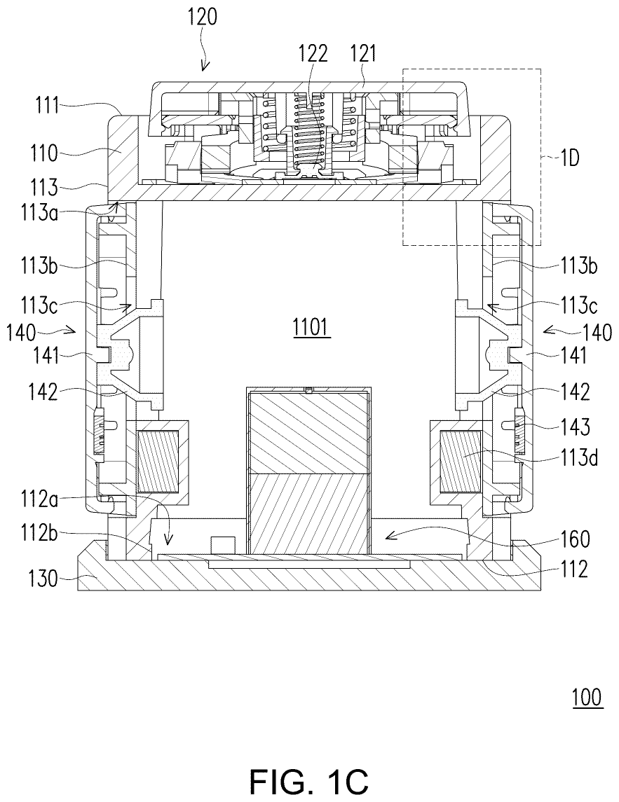

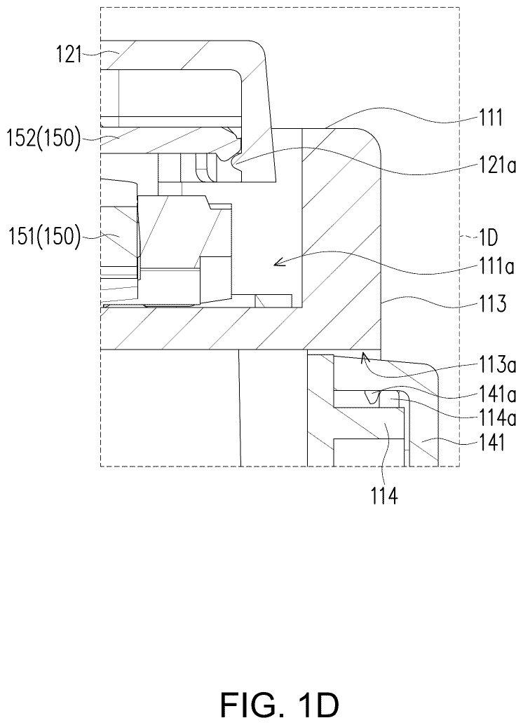

FIG. 1A is a schematic view of a keyboard accessory according to an embodiment of the disclosure. FIG. 1B is a cross-sectional schematic view of the keyboard accessory in FIG. 1A along a line segment 1B-1B. FIG. 1C is a cross-sectional schematic view of the keyboard accessory in FIG. 1A along a line segment 1C-1C. Please refer to FIG. 1A. In the embodiment, a keyboard accessory 100 includes a storage base 110, a first key 120, a base 130 and multiple second keys 140. The first key 120 and the multiple second keys 140 are detachably engaged with the storage base 110, and the first key 120 and the multiple second keys 140 may be multiple replaceable keys or multiple keys detached from the keyboard.

Through storing the first key 120 and the multiple second keys 140 on the storage base 110, the embodiment is not only convenient for users to carry around, but may also effectively reduce the risk of losing keys, facilitating users to instantly disassemble and replace keys on the keyboard according to personal needs or preferences. In addition, the storage base 110 may accommodate more keys within a limited volume. Therefore, not only the storage volume is effectively reduced, but also the selectivity of key replacement is improved.

As shown in FIG. 1A to FIG. 1C, the storage base 110 is a hollow cube or a hollow three-dimensional structure in other shapes, and has a first mounting portion 111, a second mounting portion 112 opposite to the first mounting portion 111, and multiple third mounting portions 113 located between the first mounting portion 111 and the second mounting portion 112. In detail, the first key 120 is detachably engaged with the first mounting portion 111, and the multiple second keys 140 are detachably engaged with the multiple third mounting portions 113. In addition, the base 130 is detachably sleeved on the second mounting portion 112.

In the embodiment, the first mounting portion 111 has a recess 111a, and a height-adjustable structure 150 is provided in the recess 111a. The first key 120 is detachably engaged with the height-adjustable structure 150, so the first key 120 may be pressed by a user as a way of entertainment or stress relief. The height-adjustable structure 150 includes a lifting bracket 151 engaged with a bottom part 111b of the recess 111a and a lifting platform 152 engaged with the lifting bracket 151. The lifting bracket 151 is located between the bottom part 111b and the lifting platform 152, and the first key 120 is detachably engaged with the lifting platform 152. For example, the lifting bracket 151 may be a scissor leg bracket or a butterfly bracket.

FIG. 1D is an enlarged schematic view of the region 1D in FIG. 1C. As shown in FIG. 1B to FIG. 1D, the first key 120 includes a keycap 121 engaged with the lifting platform 152 of the height-adjustable structure 150 and a trigger element 122 connected to the keycap 121. The keycap 121 has an engaging protrusion 121a to engage with an edge of the lifting platform 152. On the other hand, the trigger element 122 passes through the height-adjustable structure 150 and directly or indirectly contacts the bottom part 111b of the recess 111a. For example, the trigger element 122 may include a telescopic assembly connected to the keycap 121 and an elastic dome trigger structure connected to the telescopic assembly, and the elastic dome trigger structure may be made of rubber or silicone.

As shown in FIG. 1B, the first key 120 is provided with a key magnetic body 123 on the keycap 121, and the lifting platform 152 is provided with a platform magnetic body 152a. The key magnetic body 123 is magnetically attracted to the platform magnetic body 152a to improve the reliability of the first key 120 being installed and positioned on the first mounting portion 111. In addition, the user may quickly and precisely install and position the keycap 121 on the lifting platform 152 according to the magnetic attraction force generated between the key magnetic body 123 and the platform magnetic body 152a. For example, the key magnetic body 123 and the platform magnetic body 152a may be a combination of two magnets or a combination of a magnet and a magnetic conductive body.

As shown in FIG. 1B and FIG. 1C, the storage base 110 further has an inner space 1101 surrounded by the first mounting portion 111, the second mounting portion 112 and the multiple third mounting portions 113. The second mounting portion 112 has an opening 112a communicated with the inner space 1101 and an engaging protrusion 112b located in the opening 112a. When the base 130 is sleeved on the second mounting portion 112, the base 130 overlays or closes the opening 112a. For example, the bottom surface of the base 130 may be a flat surface to facilitate the keyboard accessory 100 to be firmly placed on the work surface and avoid tipping.

In the embodiment, the keyboard accessory 100 further includes a light emitting module 160 disposed on the base 130, and the light emitting module 160 is located in the inner space 1101. The light emitting module 160 may include a circuit board, a power supply, a vibration sensor and a light source. When the vibration sensor senses that the keyboard accessory 100 vibrates, the light source may emit light according to a signal generated by the vibration sensor. If the keyboard accessory 100 continues to vibrate, the light source emits flashing light to enrich the user's visual experience.

As shown in FIG. 1B to FIG. 1D, each third mounting portion 113 has a recess 113a, and a bottom part 113b of the recess 113a is provided with a positioning structure 114. Each second key 140 includes a keycap 141. Each keycap 141 covers the corresponding positioning structure 114 and is engaged with an edge of the corresponding positioning structure 114. In detail, each keycap 141 has an engaging protrusion 141a. Correspondingly, the edge of each positioning structure 114 is provided with an engaging protrusion 114a. The engaging protrusion 141a of each keycap 141 is engaged with the engaging protrusion 114a of the corresponding positioning structure 114 to allow each keycap 141 to be installed and fixed on the corresponding third mounting portion 113.

As shown in FIG. 1B and FIG. 1C, the bottom part 113b of each recess 113a has a perforation 113c, and each positioning structure 114 surrounds the corresponding perforation 113c. On the other hand, each second key 140 further includes a trigger element 142 connected to the keycap 141, and each trigger element 142 passes through the corresponding perforation 113c. Each perforation 113c is communicated with the inner space 1101, and a part of each trigger element 142 is located in the inner space 1101. For example, the trigger element 142 may be an elastic dome trigger structure, for example, made of rubber or silicone.

Each second key 140 is provided with a key magnetic body 143 on the keycap 141, and the bottom part 113b of each recess 113a is provided with a positioning magnetic body 113d. Each key magnetic body 143 is magnetically attracted to the corresponding positioning magnetic body 113d to improve the reliability of each second key 140 being installed and positioned on the corresponding third mounting portion 113. In addition, the user may quickly and precisely install and position each keycap 141 on the corresponding third mounting portion 113 according to the magnetic attraction force generated between each key magnetic body 143 and the corresponding positioning magnetic body 113d. For example, each key magnetic body 143 and the corresponding positioning magnetic body 113d may be a combination of two magnets or a combination of a magnet and a magnetic conductive body.

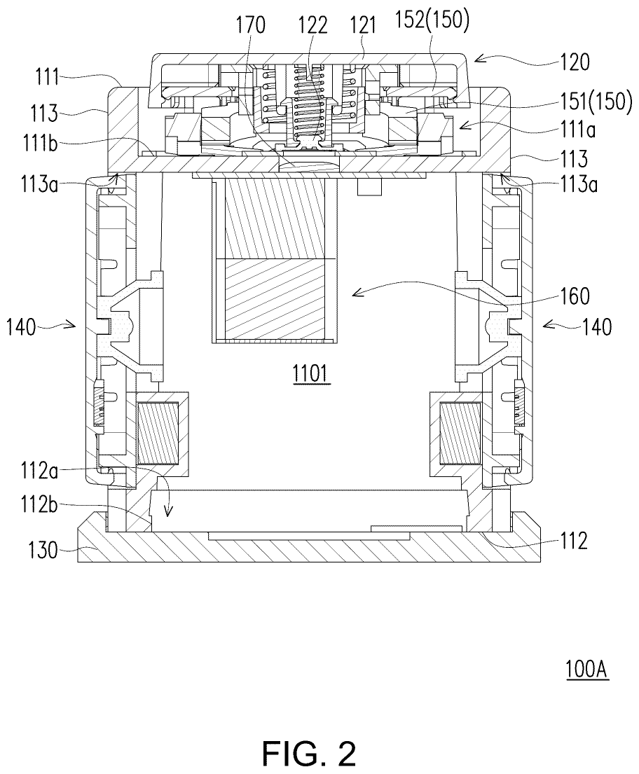

FIG. 2 is a cross-sectional schematic view of a keyboard accessory according to another embodiment of the disclosure. Please refer to FIG. 2. The design of a keyboard accessory 100A of the embodiment is roughly the same as the design of the keyboard accessory 100 of the previous embodiment. The main difference between the two is the configuration of the light emitting module 160 and the actuation method of light emission.

In the embodiment, the light emitting module 160 is disposed in the inner space 1101 and is fixed on an inner wall surface opposite to the bottom part 111b of the recess 111a in the inner space 1101. In detail, the bottom part 111b of the recess 111a is provided with a trigger switch 170, and the light emitting module 160 is electrically coupled to the trigger switch 170. On the other hand, the trigger element 122 of the first key 120 passes through the height-adjustable structure 150 and is aligned with the trigger switch 170. When a user presses the first key 120, the trigger element 122 contacts the trigger switch 170 to allow the trigger switch 170 to generate a trigger signal. The light emitting module 160 may emit light according to the trigger signal generated by the trigger switch 170. If the user repeatedly presses the first key 120, the light emitting module 160 emits flashing light.

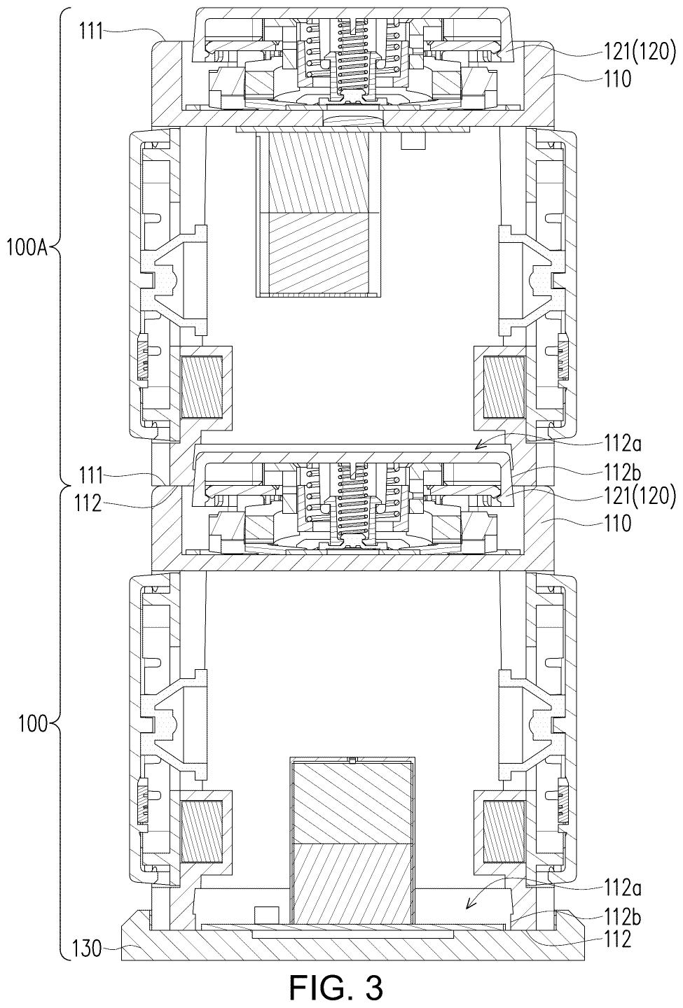

FIG. 3 is a schematic view of a combination of the keyboard accessory in FIG. 1C and the keyboard accessory in FIG. 2. Please refer to FIG. 1C, FIG. 2 and FIG. 3. A user may remove the base 130 of the keyboard accessory 100A to allow the opening 112a and the engaging protrusion 112b located in the opening 112a to be exposed to the outside. Next, the user may sleeve the opening 112a of the storage base 110 of the keyboard accessory 100A on the keycap 121 of the first key 120 of the keyboard accessory 100, or insert the keycap 121 of the first key 120 of the keyboard accessory 100 into the opening 112a of the storage base 110 of the keyboard accessory 100A, so that the keycap 121 of the first key 120 of the keyboard accessory 100 is engaged by the engaging protrusion 112b in order to overlay and fix the keyboard accessory 100A on the keyboard accessory 100 and facilitate the user to carry multiple keyboard accessories at the same time. For example, when the keyboard accessory 100A is overlaid and fixed on the keyboard accessory 100, the second mounting portion 112 of the storage base 110 of the keyboard accessory 100A may contact the first mounting portion 111 of the storage base 110 of the keyboard accessory 100.

In other examples, the user may remove the base 130 of the keyboard accessory 100 to allow the opening 112a and the engaging protrusion 112b located in the opening 112a to be exposed to the outside. Next, the user may sleeve the opening 112a of the storage base 110 of the keyboard accessory 100 on the keycap 121 of the first key 120 of the keyboard accessory 100A, or insert the keycap 121 of the first key 120 of the keyboard accessory 100A into the opening 112a of the storage base 110 of the keyboard accessory 100, so that the keycap 121 of the first key 120 of the keyboard accessory 100A is engaged by the engaging protrusion 112b in order to overlay and fix the keyboard accessory 100 on the keyboard accessory 100A.

In other examples, the at least two keyboard accessories 100 or the at least two keyboard accessories 100A may be overlaid and fixed in the same or similar manner.

In summary, in the keyboard accessory according to the disclosure, multiple replaceable keys are detachably engaged with the storage base. This design is not only convenient for users to carry around, but may also effectively reduce the risk of losing keys, facilitating users to instantly disassemble and replace keys on the keyboard according to personal needs or preferences. In addition, the storage base may accommodate more keys within a limited volume. Therefore, not only the storage volume is effectively reduced, but also the selectivity of key replacement is improved. In some examples, at least one of the multiple keys engaged on the storage base may be pressed by a user as a way of entertainment or stress relief. In some examples, the keyboard accessory may emit flashing light to enrich the user's visual experience.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A keyboard accessory, comprising:
a storage base, having a first mounting portion, a second mounting portion opposite to the first mounting portion, and a plurality of third mounting portions located between the first mounting portion and the second mounting portion;
a first key, detachably engaged with the first mounting portion;
a base, detachably sleeved on the second mounting portion; and
a plurality of second keys, detachably engaged with the third mounting portions.

2. The keyboard accessory according to claim 1, wherein the first mounting portion has a recess, and a height-adjustable structure is provided in the recess, and the first key is detachably engaged with the height-adjustable structure.

3. The keyboard accessory according to claim 2, wherein the height-adjustable structure comprises a lifting bracket engaged with a bottom part of the recess and a lifting platform engaged with the lifting bracket, and the lifting bracket is located between the bottom part and the lifting platform, and the first key is detachably engaged with the lifting platform.

4. The keyboard accessory according to claim 3, wherein the first key is provided with a key magnetic body, and the lifting platform is provided with a platform magnetic body, and the key magnetic body is magnetically attracted to the platform magnetic body.

5. The keyboard accessory according to claim 2, further comprising:
a light emitting module, disposed in the storage base, wherein a bottom part of the recess is provided with a trigger switch, and the light emitting module is electrically coupled to the trigger switch, and the first key comprises a keycap engaged with the height-adjustable structure and a trigger element connected to the keycap, wherein the trigger element passes through the height-adjustable structure and is aligned with the trigger switch.

6. The keyboard accessory according to claim 1, wherein the storage base further has an inner space, and the second mounting portion has an opening communicated with the inner space, and the keyboard accessory further comprises a light emitting module disposed on the base, wherein the base overlays the opening, and the light emitting module is located in the inner space.

7. The keyboard accessory according to claim 1, wherein the storage base further has an inner space, and the second mounting portion has an opening communicated with the inner space and an engaging protrusion located in the opening, the base overlays the opening, and when the base is detached from the second mounting portion, the engaging protrusion is exposed to the outside.

8. The keyboard accessory according to claim 1, wherein each of the third mounting portions has a recess, and a bottom part of the recess is provided with a positioning structure, and each of the second keys comprises a keycap, wherein each of the keycaps covers the corresponding positioning structure and is engaged with an edge of the corresponding positioning structure.

9. The keyboard accessory according to claim 8, wherein the bottom part of each of the recesses has a perforation, and each of the positioning structures surrounds the corresponding perforation, each of the second keys further comprises a trigger element connected to the keycap, and each of the trigger elements passes through the corresponding perforation.

10. The keyboard accessory according to claim 8, wherein each of the keycaps is provided with a key magnetic body, and the bottom part of each of the recesses is provided with a positioning magnetic body, and each of the key magnetic bodies is magnetically attracted to the corresponding positioning magnetic body.
